(19) United States
(12) Patent Application Publication
(10) Pub. No.: US 2025/0120873 A1
(43) Pub. Date: Apr. 17, 2025

(54) UNIDIRECTIONAL ACTUATOR WITH CUSTOMIZABLE NONLINEAR SERIES ELASTICITY

(71) Applicant: Northeastern University, Boston, MA (US)

(72) Inventors: Max Shepherd, Boston, MA (US); Divyansh Gupta, Boston, MA (US)

(21) Appl. No.: 18/911,616

(22) Filed: Oct. 10, 2024

Related U.S. Application Data
(60) Provisional application No. 63/543,773, filed on Oct. 12, 2023.

(51) Int. Cl. A61H 3/00; A61H 1/02; B25J 9/00; B25J 9/10; B25J 13/08

(52) U.S. Cl. CPC A61H 3/00; B25J 9/0006; B25J 9/104; B25J 13/088; A61H 1/0266

(57) ABSTRACT

The present disclosure provides a unidirectional actuator with customizable series elasticity. The actuator includes a winch, a cable coupled to the winch, a spring-loaded idler engaged with the cable, and a cam coupled to the spring-loaded idler. The spring-loaded idler comprises an idler arm and a spring member. The cam is shaped to provide a nonlinear stiffness versus force characteristic for the spring-loaded idler. The actuator can be applied in various applications, such as an ankle exoskeleton.

### CROSS-REFERENCE TO RELATED APPLICATIONS

This application claims the benefit of priority U.S. Provisional Patent Application No. 63/543,773, filed on Oct. 12, 2023; which is hereby incorporated by reference in its entirety.

### FIELD OF INVENTION

The present disclosure relates to actuators, and more particularly to unidirectional actuators with customizable nonlinear series elasticity.

### BACKGROUND

Actuators play a crucial role in various mechanical and robotic systems, converting energy into motion or force. In many applications, precise control of force and motion is essential for optimal performance and safety. Many applications require soft, compliant behavior at low forces for gentle interactions, while also demanding the ability to exert larger forces when necessary.

A variety of methods and systems are known for providing force control. However, these methods and systems often face challenges when interacting with the environment or when fine force control is required. For example, the cables of unidirectional actuators can tangle or have too much slack when the end of the actuator (e.g., end of the cable) is extended or retracted.

Furthermore, the management of inertia, especially during rapid contact with the environment, can be a challenge for conventional actuators. The rotational inertia of a motor's rotor can lead to large shock loads upon contact, potentially causing damage or compromising the system's performance. Additionally, achieving accurate force control at the end effector of such actuators can be problematic due to the coupled inertia of the rotor and friction within the transmission system.

Force control in large motors can present particular difficulties, especially at lower force levels. The output impedance of traditional actuators typically does not scale well with the magnitude of force being applied, leading to inconsistent performance across different force ranges. Force control of the end of the actuator can also be difficult because of the coupled inertia and friction in the transmission.

In various robotic applications, such as exoskeletons or prosthetic devices, the ability to quickly engage and disengage an actuator is crucial. For instance, in gait-assistive devices, there can be a need to allow free movement during certain phases while providing support and force application during others. Achieving this seamless transition while maintaining control and safety can be a challenge in actuator design.

Thus, there remains a need for actuators that offer customizable force characteristics, better force control across a wide range, and efficient energy management, all of which can enhance the capabilities of various mechanical and robotic systems.

### SUMMARY

The purpose and advantages of the disclosed subject matter will be set forth in and apparent from the description that follows, as well as will be learned by practice of the disclosed subject matter. Additional advantages of the disclosed subject matter will be realized and attained by the methods and systems particularly pointed out in the written description and claims hereof, as well as from the appended drawings.

To achieve these and other advantages in accordance with the purpose of the disclosed subject matter, as embodied and broadly described, the disclosed subject matter includes a unidirectional actuator. The unidirectional actuator comprises a winch, a cable coupled to the winch, a spring-loaded idler engaged with the cable, and a cam coupled to the spring-loaded idler. The spring-loaded idler comprises an idler arm and a spring member. A rotation of the cam varies the stiffness of the spring member.

The unidirectional actuator may further comprise a drive mechanism coupled to the winch. The drive mechanism may be configured to rotate the winch. The drive mechanism may comprise a motor. The unidirectional actuator may further comprise an encoder configured to measure the rotation of the idler and/or cam. The unidirectional actuator may further comprise a controller configured to control at least one of a position or velocity of the drive mechanism or current supplied to the drive mechanism based on a measured rotation of the cam. The unidirectional actuator may further comprise a cam roller configured to engage with the cam. The rotation of the cam may deflect the spring member. The spring member may bias the idler arm towards the spring member. The spring member may comprise a leaf spring. The unidirectional actuator may further comprise a frame. The winch and the cam may be rotatably coupled to the frame. The unidirectional actuator may further comprise an idler guiding mechanism configured to guide the idler arm along a predetermined path. The idler guiding mechanism may comprise a channel configured to receive a portion of the idler arm. The channel may have a curved shape. The unidirectional actuator may comprise a plurality of routing members configured to route the cable. The unidirectional actuator may be used in an exoskeleton. An exoskeleton may comprise the unidirectional actuator. A robotic arm may comprise at least one unidirectional actuator. The rotation of the cam may vary the stiffness of the spring member in a nonlinear manner. The exterior surface of the cam may define a predetermined stiffness profile for the spring member when the cam rotates. At least a portion of the exterior surface of the cam may be shaped to increase the stiffness of the spring member with increasing force on the cable. A portion of the exterior surface of the cam may be shaped to provide a constant force on the cable.

It is to be understood that both the foregoing general description and the following detailed description are exemplary and are intended to provide further explanation of the disclosed subject matter claimed.

The accompanying drawings, which are incorporated in and constitute part of this specification, are included to illustrate and provide a further understanding of the method and system of the disclosed subject matter. Together with the description, the drawings explain the principles of the disclosed subject matter.

### BRIEF DESCRIPTION OF FIGURES

A detailed description of various aspects, features, and embodiments of the subject matter described herein is provided with reference to the accompanying drawings, which are briefly described below. The drawings are illustrative and are not necessarily drawn to scale, with some components and features being exaggerated for clarity. The drawings illustrate various aspects and features of the present subject matter and may illustrate one or more embodiment(s) or example(s) of the present subject matter in whole or in part.

FIG. 1 is a front view of an implementation of a unidirectional actuator.

FIG. 2A is a perspective view of an implementation of a unidirectional actuator coupled to an ankle exoskeleton.

FIG. 2B is a front view of an implementation of a unidirectional actuator coupled to an ankle exoskeleton shown in FIG. 2A.

FIG. 3A is a perspective view of an implementation of a unidirectional actuator coupled to an ankle exoskeleton.

FIG. 3B is a front view of an implementation of a unidirectional actuator coupled to an ankle exoskeleton shown in FIG. 3A.

FIG. 4 shows a plot of a cam profile.

FIG. 5 shows a plot of a force in a cable as a function of an angle of an idler arm.

### DETAILED DESCRIPTION

The following description sets forth exemplary aspects of the present disclosure. It should be recognized, however, that such description is not intended as a limitation on the scope of the present disclosure. Rather, the description also encompasses combinations and modifications to those exemplary aspects described herein.

References herein to positions of elements (e.g., “top”, “bottom”) are merely used to describe the orientation of various elements in the FIGURES. It should be noted that the orientation of various elements may differ according to other exemplary implementations, and that such variation are intended to be encompassed by the present disclosure.

The present disclosure provides a unidirectional actuator with customizable series elasticity. The actuator system described herein may offer improved force control, adaptability across different force ranges, and efficient energy management. These features may make it suitable for a variety of applications, including but not limited to, robotic systems, mechanical systems, and wearable devices such as exoskeletons.

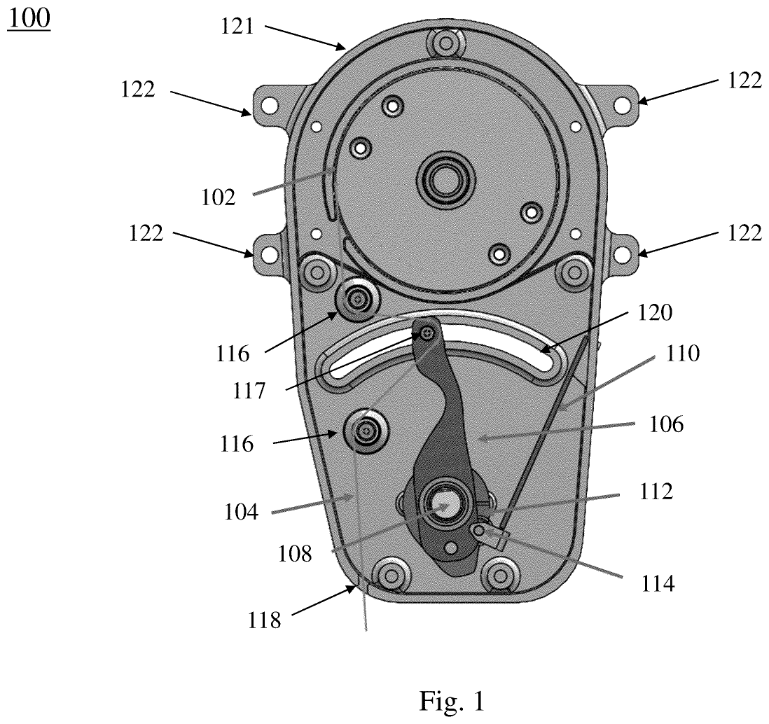

Referring now to FIG. 1, and in brief overview, a front view of an implementation of a unidirectional actuator is shown that includes a winch 102, a cable 104 coupled to the winch 102, a spring-loaded idler engaged with the cable 104, and a cam 112 coupled to at least a portion of the spring-loaded idler. The spring-loaded idler comprises an idler arm 106 and a spring member 110. The spring-loaded idler may be configured to act as a series spring, providing elasticity to the actuator system, which can be customized based on the shape of the cam 112. This series elasticity can allow the system to absorb shock loads and provide a smooth and controlled force output. The spring-loaded idler may be configured to accommodate a range of cable tensions.

Still referring to FIG. 1, and in greater detail, the unidirectional actuator can comprise a frame. The winch 102, idler arm 106, and the cam 112 can be rotatably coupled to the frame 121. The frame 121 can include attachment points 122 configured to couple (e.g., fixedly couple) the frame to an exoskeleton or a robotic system. In some implementations, the attachment points 122 are openings extending through a thickness of the frame 121 and are shaped and sized to receive fasteners.

The cam 112 can be coupled to the idler arm 106 such that a rotation of the cam 112 rotates the idler arm. In some implementations, the cam 112 may be coupled to the idler arm 106 through various means, such as mechanical fasteners (e.g., screws, nuts, bolts, pins, dowels), adhesives, or a combination thereof. In some implementations, the idler arm 106 and the cam 112 are two separate components. In some implementations, the idler arm 106 and the cam 112 are a single component. The idler arm 106 comprises an elongated body having a first end and a second end in which the idler arm 106 rotates about a pivot point 108 at the first end. The rotation can occur about an axis that is substantially perpendicular to the longitudinal axis of the idler arm. The cam 112 can also rotate about the pivot point 108. In some implementations, the pivot point 108 comprises a shaft that is coupled to the frame 121 and the cam 112 and the idler arm 106 comprise a bearing, allowing the cam 112 and idler arm 106 to rotate together about the shaft.

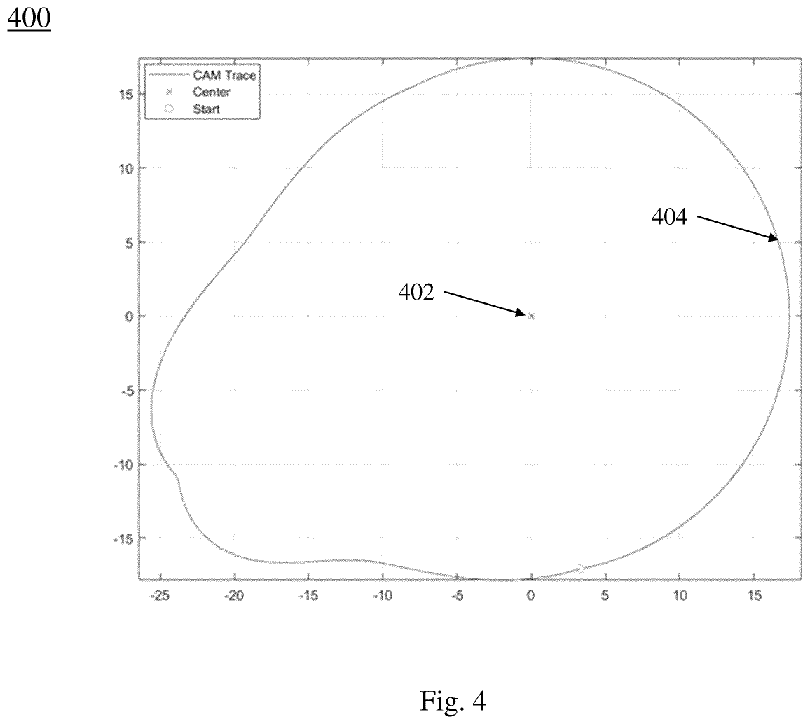

The cam 112 can have a top surface, a bottom surface and a thickness therebetween. The cam 112 can rotate about an axis substantially perpendicular to the top and bottom surface of the cam. A cam roller 114 can be movably coupled to the frame 121 and positioned proximal to the cam 112 so that it contacts the exterior surface of the cam. The exterior surface of the cam 112 that is substantially perpendicular to the top surface and bottom surface of the cam can have a profile or contour that defines a predetermined stiffness profile for the spring member 110 as the cam 112 rotates. FIG. 4 shows a plot of an exemplary cam profile 404 having a center 402. In some implementations, the rotation of the cam 112 varies the stiffness of the spring member 110 in a nonlinear manner. The cam 112 can be shaped to produce any non-linear stiffness versus force characteristic. The nonlinear stiffness versus force characteristic provided by the cam 112 may include a low stiffness region at low forces and increasing stiffness with increasing force. This characteristic may allow for soft, compliant behavior at low forces for soft contact interactions, while also providing the ability to quickly exert larger forces when necessary without the need to reel in a large amount. Soft contact interactions may be required when a robotic arm that is not contacting an object or surface suddenly makes soft contact. In this way, the actuator system's output impedance, which is a measure of the actuator's frequency-dependent resistance to displacements of its output, can scale with the magnitude of force being applied. By using a non-linear spring member, a more human-like scaling of force control ability with force magnitude can be achieved.

As the cam 112 rotates, the position of the cam roller 114 can change, leading to varying points of contact with the spring member 110. The cam roller 114 can exert a pressing force against the spring member 110, causing it to displace in reponse to the pressing force. The spring member 110 can comprise a leaf spring which can deflect or flex in response to the movement of the cam roller 114.

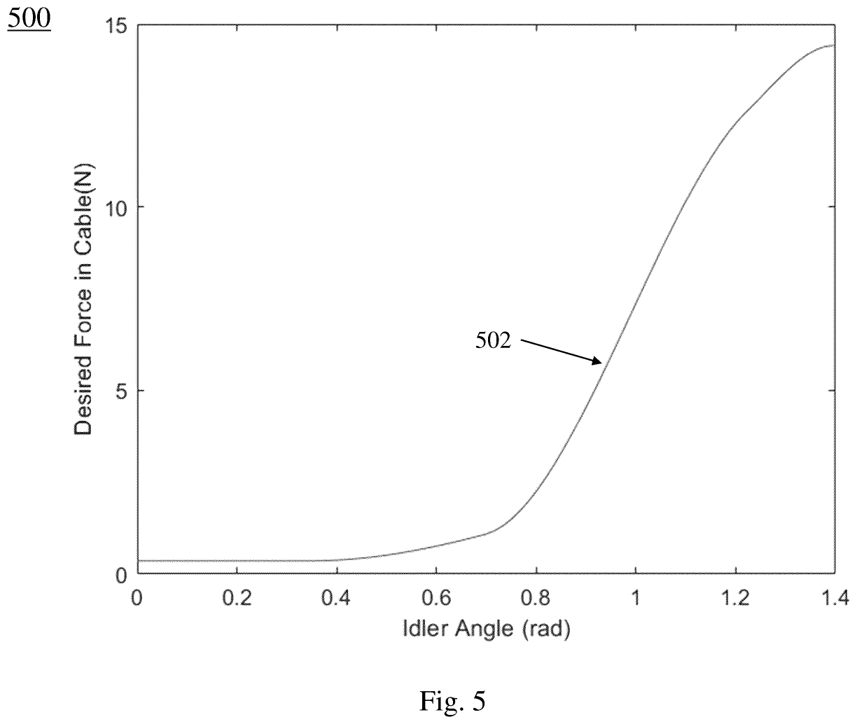

In some implementations, a portion of the exterior surface of the cam 112 can be shaped to increase the stiffness of the spring member 110 with increasing force on the cable 104. By having the stiffness increase with force, the amount of energy stored in the spring member can be lowered compared to a spring member having low stiffness at all forces, thereby decreasing the size and mass of the spring member. In some implementations, a portion of the exterior surface of the cam 112 can be shaped to provide a constant force on the cable 104. For example, the constant force region may be designed to provide a low force output for applications requiring delicate interactions, or a high force output for applications requiring robust interactions. This may be particularly useful in applications where a constant or low bias force is needed, such as in robotic systems interacting with fragile objects or in wearable devices interacting with the human body (e.g., an ankle exoskeleton). By way of example, in an ankle exoskeleton that includes the actuator system, the actuator system may be disengaged from the ankle during the swing phase of the gait to allow for free movement of the ankle. During this motion, a constant force region of the cam and/or low stiffness region of the cam may be used to provide a low bias force to keep the cable taut and allowing for quick and smooth engagement when a larger force is required during the stance phase of the gait. This feature also allows the angle of the ankle to be determined without additional sensors located directly at the joint, as the cable is always at least slightly taut. FIG. 5 shows an exemplary plot of the desired force in the cable (measured in Newtons) as a function of the angle of the idler arm 206, which is coupled to the cam 112. The plot shows a line 502 depicting a non-linear relationship between the idler arm angle and the force in the cable.

Still referring to FIG. 1, the unidirectional actuator can include a drive mechanism coupled to the winch (not shown) that is configured to rotate the winch 102. The drive mechanism can be configured to convert rotational motion of the winch into linear motion of the cable 104. In this way, a rotation of the winch 102 can wind or unwind the cable 104. The drive mechanism can comprise a motor (e.g., a drone motor, DC motor, brushless DC motor, stepper motor, servo motor, gear motor, AC motor). The motor can be controlled to rotate the winch 102 at different speeds, thereby adjusting the tension in the cable and the resulting linear motion. Motor control may be based on various factors, including but not limited to, the desired force output, the current position or state of the device or system being actuated, and the feedback from an encoder measuring the rotation of the cam. The motor may be selected based on the specific requirements of the application, including but not limited to, the desired speed, torque, and power consumption.

The winch 102 may be configured to handle a variety of loads and may be constructed from a range of materials suitable for the intended application. The winch 102 can be a substantially cylindrical component around which the cable 104 is wound. The winch 102 can include grooves or flanges to guide the cable 104. A first end of the cable 104 can be securely attached to an anchor point of the winch 102 while the second end of the cable 104 can extend through a notch 118 of the frame 121 and a portion of the cable 104 between the first and second end of the cable 104 can be engaged with the idler arm 106. The frame 121 can include a plurality of routing members 116 configured to route the cable 104 from the winch 102 to the notch 118. The routing members 116 can be substantially cylindrical in shape, allowing the cable 104 to partially wrap around the routing members. In some implementations, a portion of the cable 104 can partially wrap around a projection 117 extending from the top surface of the idler arm 106 such that the idler arm 106 rotates when the drive mechanism drives the winch 102, responsively winding or unwinding cable 104 (depending on the direction of winch rotation). In some implementation, the spring member 110 biases the idler arm 106 towards the spring member.

The cable 104 may be made of a variety of materials, including but not limited to, metal, synthetic fibers, or a combination thereof. The cable 104 may be selected based on the desired strength, flexibility, and durability requirements of the specific application.

The unidirectional actuator can include an idler guiding mechanism 120 (e.g., a slot, channel, groove) configured to guide the idler arm 106 along a predetermined path. For example, the frame 121 can comprise a slot 120 that extends through the thickness of the frame 121 and is configured to receive a portion of the idler arm 106 (e.g., a projection extending from the bottom surface of the idler arm 106 into the slot 120). The slot 120 can have a curved shape which follows the trajectory of the second end of the idler arm 106 when the idler arm rotates about the pivot point 108.

The unidirectional actuator can include a feedback control system comprising an encoder and a controller. In some implementations, the encoder may be a rotary encoder, an optical encoder, a magnetic encoder, or any other type of encoder suitable for measuring rotation. In some implementations, the controller may be a digital controller, an analog controller, a programmable logic controller, or any other type of controller suitable for controlling the drive mechanism. The encoder can be positioned in proximity to the cam 112 and coupled (e.g., fixedly coupled) to the frame 121. The encoder can be configured to measure the rotation of the cam 112, which indirectly measures the displacement of the spring member 110 and the force in the cable 104. This measurement can be used to control the position of the drive mechanism (e.g., rotation of the motor) and/or current supplied to the drive mechanism, thereby producing a desired force in the cable 104. The encoder can detect the position of the cam 112 (e.g., absolute or relative angle of rotation of the cam) continuously or at regular intervals and generate output signals corresponding to the cam's current position. The output signals of the encoder can be transmitted in real-time or near real-time feedback to the controller such as a Proportional-Integral-Derivative controller. By comparing the measured rotation of the cam 112 with a predetermined setpoint or desired force in the cable 104, the controller can be configured to dynamically adjust the drive mechanism (e.g., control the motor position and/or current based on the measured rotation of the cam). By adjusting the motor current, the controller may control the speed and torque of the motor. Adjusting the drive mechanism can rotate the winch 102 which can responsively rotate the idler arm 106 and the coupled cam 112 to provide the desired force in the cable 104. The controller's adjustments can maintain the cable 104 taut during operation. A taut cable may allow for quick but smooth engagement when a large force needs to be applied. This may be particularly useful in applications where rapid changes in force are required. By keeping the cable taut, the endpoint position of the cable may be known without the need for additional instrumentation at the endpoint of the cable or system. This may simplify the design of the system and reduce the overall cost and complexity.

Elements of the actuator system (e.g., idler arm 106, cam 112) can be formed via 3D printing, molding, machining, or other fabrication techniques. Elements of the actuator system can be formed of various materials, including but not limited to, metal, plastic, composite materials such as carbon fiber, or combinations thereof.

In some implementations, the unidirectional actuator comprises a pulley system, which can effectively increase the force produced by the actuator system.

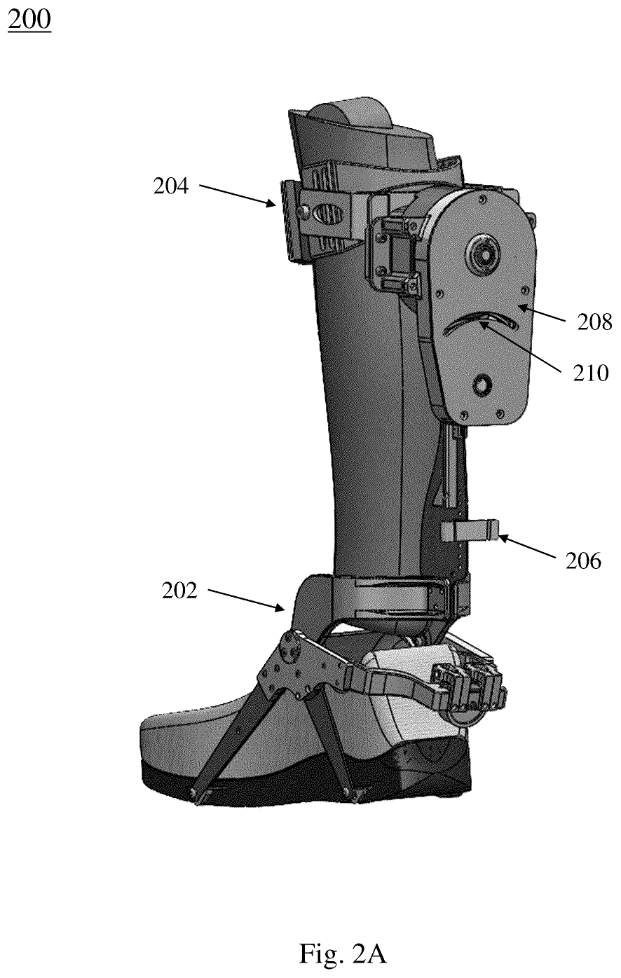

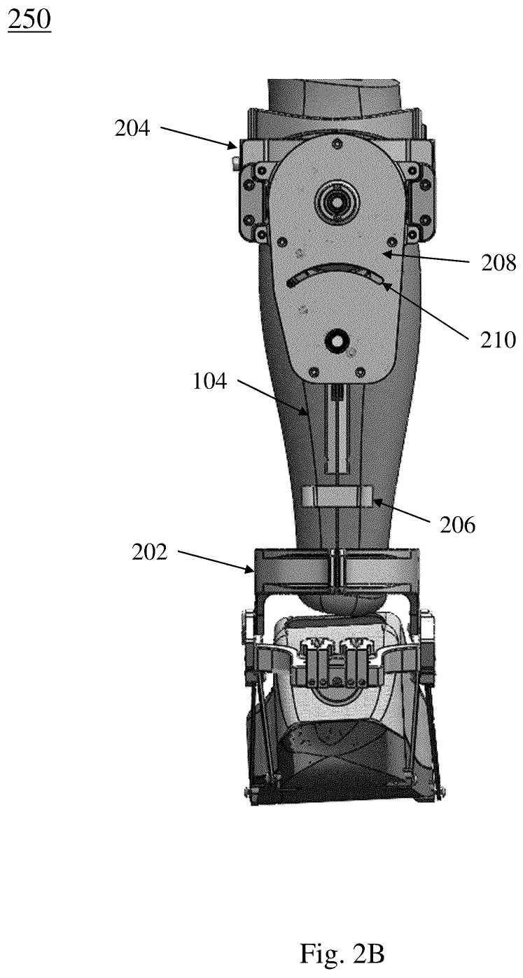

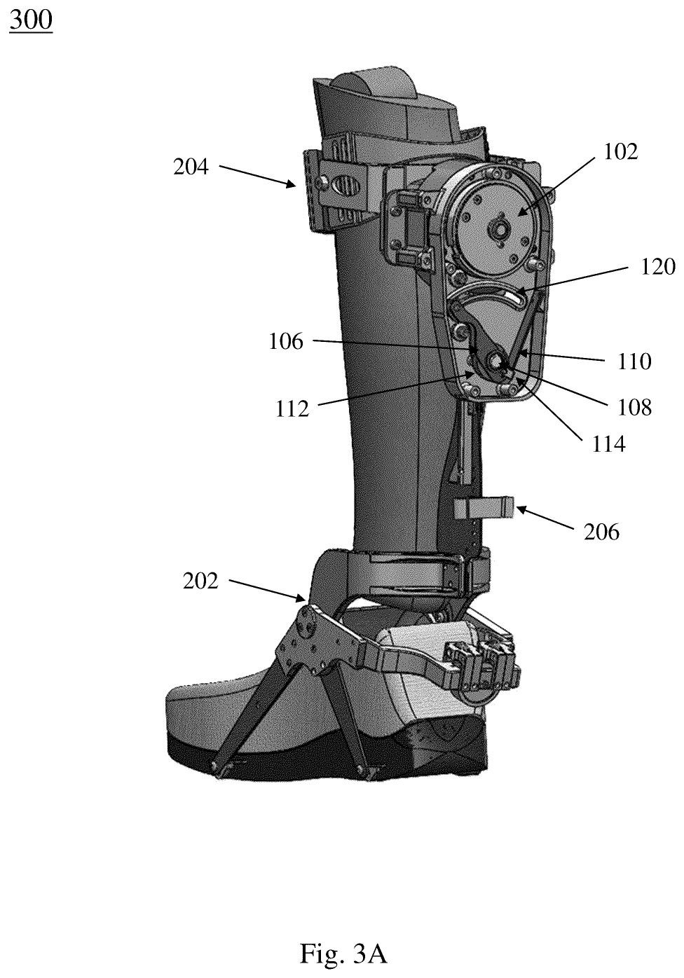

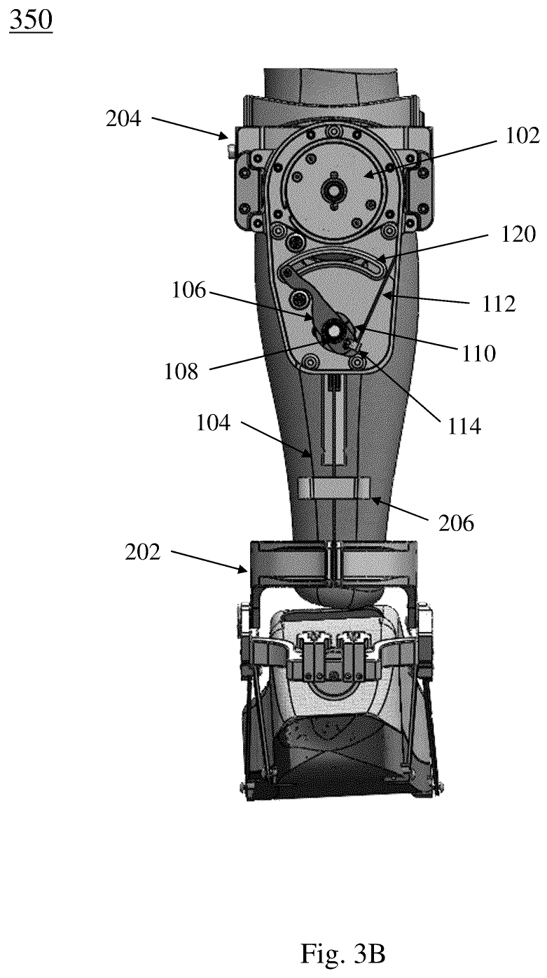

In some implementations, an exoskeleton (e.g., ankle exoskeleton) comprises a unidirectional actuator. In some implementations, the unidirectional actuator may be configured for use in an ankle exoskeleton. FIGS. 2A-3B show an implementation of a unidirectional actuator in an ankle skeleton. The ankle exoskeleton may be a wearable device designed to assist or augment the natural movement of the ankle joint. The unidirectional actuator may be coupled to the ankle exoskeleton in a manner that allows it to apply forces to the ankle joint, thereby assisting in the movement of the ankle. The ankle exoskeleton system may include an ankle attachment mechanism 202 coupled to the cable and a leg attachment mechanism 204 to couple the actuator system to the user's leg. The ankle attachment mechanism 202 may be configured to securely attach the exoskeleton to the user's ankle, allowing the force produced by the unidirectional actuator to be effectively transmitted to the ankle joint. The ankle attachment mechanism 202 may be adjustable to accommodate different ankle sizes and shapes, and may be constructed from a variety of materials, including but not limited to, metal, plastic, or a combination thereof.

In some implementations, the ankle attachment mechanism 202 may be coupled to the cable 104 in a manner that allows the linear motion of the cable to be converted into a rotational motion at the ankle joint. This conversion may be achieved through various means, such as a pulley system, a gear system, or a linkage system, among others. In some implementations, the unidirectional actuator may be distally located from the ankle attachment mechanism 202. In such implementations, the cable 104 may be routed through a conduit or a guide 206 to reach the ankle attachment mechanism 202. In some implementations, the unidirectional actuator includes a cover 208 having a slot 210 that align with and corresponds to the slot 120 of the frame 121.

While the unidirectional actuator system has been described in the context of an ankle exoskeleton, it may be appreciated that the system may be applied in a variety of other applications. For instance, in some implementations, the actuator system may be used in other types of exoskeletons, such as knee exoskeletons, full-body exoskeletons, back exoskeletons, hand/finger exoskeletons. These exoskeletons may be designed to assist or augment the natural movement of various joints in the human body. In some implementations, the actuator system may be used in medical devices, such as prosthetics or orthotics.

In some implementations, the actuator system may be used in robotic systems. These robotic systems may include, but are not limited to, industrial robots, service robots, or humanoid robots. The unidirectional actuator may be used to control the movement of various parts of the robot, such as the arms, legs, or fingers. The customizable series elasticity provided by the actuator system may allow the robot to interact with its environment in a controlled and adaptable manner. In some implementations, a joint of a robotic system comprises a plurality of unidirectional actuators. In some implementations, a joint of a comprises two unidirectional actuators, which can allow for movement in opposing directions. When providing bidirectional actuation with a combination of two actuators, the forces exerted by the cables subtract to determine force or moment on the joint, but their stiffnesses add. In this way, stiffness can be controlled independently from overall force/torque. In some implementations, the actuator system may be used in entertainment applications, such as animatronics or virtual reality systems.

The actuator system may be used in other applications not specifically mentioned herein. The unidirectional actuator may be used to control various components of these other applications, depending on the specific requirements of the application. The customizable series elasticity provided by the actuator system may allow for precise control over the operation of these components, enhancing the performance and versatility of the application.

A number of implementations have been described. Nevertheless, it will be understood that various modifications may be made without departing from the spirit and scope of the disclosure. Accordingly, other implementations are within the scope of the following claims.

1. A unidirectional actuator, comprising:
a winch;
a cable coupled to the winch;
a spring-loaded idler engaged with the cable, the spring-loaded idler comprising an idler arm and a spring member; and
a cam coupled to the spring-loaded idler, wherein a rotation of the cam varies a stiffness of the spring member.

2. The unidirectional actuator of claim 1, further comprising a drive mechanism coupled to the winch, wherein the drive mechanism is configured to rotate the winch.

3. The unidirectional actuator of claim 1, the drive mechanism comprising a motor.

4. The unidirectional actuator of claim 1, further comprising an encoder configured to measure the rotation of the cam.

5. The unidirectional actuator of claim 1, further comprising a controller configured to control at least one of a position of the drive mechanism or current supplied to the drive mechanism based on a measured rotation of the cam.

6. The unidirectional actuator of claim 1, further comprising a cam roller configured to engage with the cam.

7. The unidirectional actuator of claim 1, wherein the rotation of the cam deflects the spring member.

8. The unidirectional actuator of claim 1, wherein the spring member biases the idler arm towards the spring member.

9. The unidirectional actuator of claim 1, the spring member comprising a leaf spring.

10. The unidirectional actuator of claim 1, further comprising a frame, wherein the winch and the cam are rotatably coupled to the frame.

11. The unidirectional actuator of claim 1, further comprising an idler guiding mechanism configured to guide the idler arm along a predetermined path.

12. The unidirectional actuator of claim 11, the idler guiding mechanism comprising a channel configured to receive a portion of the idler arm.

13. The unidirectional actuator of claim 11, wherein the channel has a curved shape.

14. The unidirectional actuator of claim 1, further comprising a plurality of routing members configured to route the cable.

15. An exoskeleton comprising the unidirectional actuator of claim 1.

16. A robotic arm comprising at least one unidirectional actuator of claim 1.

17. The unidirectional actuator of claim 1, wherein the rotation of the cam varies the stiffness of the spring member in a nonlinear manner.

18. The unidirectional actuator of claim 1, wherein the exterior surface of the cam defines a predetermined stiffness profile for the spring member when the cam rotates.

19. The unidirectional actuator of claim 18, wherein at least a portion of the exterior surface of the cam is shaped to increase the stiffness of the spring member with increasing force on the cable.

20. The unidirectional actuator of claim 1, wherein a portion of the exterior surface of the cam is shaped to provide a constant force on the cable.
